(19) United States
(12) Patent Application Publication
(10) Pub. No.: US 2008/0143024 A1
(43) Pub. Date: Jun. 19, 2008

(54) METHOD AND APPARATUS FOR PRODUCING POLYSTYRENE TUBULAR SHRINK FILM VIA FILM BLOW MOLDING

(76) Inventor: Chui-Hsian WEI, Kaohsiung City (TW)

Correspondence Address: LEONG C LEI, PMB # 1008, 1867 YGNACIO VALLEY ROAD, WALNUT CREEK, CA, 94598, US

(21) Appl. No.: 11/610,514

(22) Filed: Dec. 14, 2006

(51) Int. Cl. B29C 55/28; B29C 49/04; B29C 49/78

(52) U.S. Cl. 264/562; 425/66

(57) ABSTRACT

In a method and apparatus for producing polystyrene tubular shrink film via film blow molding, a polystyrene plastic material is extruded into a circular tubular film, which is cooled and then uniformly heated in a special hot water tank to become softened. Hot air is then blown into the softened tubular film, and two sequentially arranged speed-controlled pressure guide roller sets are set to two different operating speeds, so that the softened tubular film is transversely and longitudinally stretched and thinned to form a stretched tubular film, which is then passed through a setting treatment system to form a thermally set tubular film and be finally wound in a take-up system into a roll for storage. The method and apparatus is simple, low cost, and easy to operate, and the product thereof is environment friendly to help in economic development.

### BACKGROUND OF THE INVENTION

(a) Technical Field of the Invention

The present invention relates to a method and apparatus for producing polystyrene tubular shrink film via film blow molding, and more particularly to a method and apparatus that uses polystyrene (PS), i.e. styrene-butadiene copolymer (SBC), as a raw material to form a primary blown tubular film via blow molding, stretches the primary blown tubular film to reduce a thickness thereof, and stabilizes the stretched tubular film to form a thermally set tubular film.

(b) Description of the Prior Art

Due to its property of thermal shrinkage, plastic shrink film has been widely used as a packaging material to tightly and fitly wrap and attach to the surface of an object, so that the object has a beautiful, wet-proof, and dust-tight package to advantageously increase its value. Currently, there are two ways for producing the plastic shrink film, namely, a T-die extrusion method and a film blow molding method. In the T-die extrusion method, a T-die is used to extrude a plastic material, so as to form a non-stretched film. The non-stretched film is cooled with a cooling device, and then longitudinally and transversely stretched using a hot roller set and a complicate and big thermal stretching machine or tenter. The stretched film is then cooled by a cooling roller set, and finally hauled out using a haul mechanism and would by a take-up mechanism into a roll for storage.

The following disadvantages are found in the T-die extrusion method:
1. The machinery therefor is complicate and big in volume to necessitate a large plant house and high amount of investment, and consumes high amount of power.
2. A large portion about 15% of the produced shrink film is clamped by fixture during production process, and must be trimmed off to become scrap, causing unnecessary waste in the production. Therefore, the T-die extrusion method is not suitable for producing items in small quantity.
3. The film blow molding method uses small-scaled and low-cost machinery. However, the environment friendly polystyrene plastic material could not be used in this method to produce shrink film. Up to date, there is not any polystyrene tubular shrink film that is produced by film blow molding.

### SUMMARY OF THE INVENTION

The primary purpose of the present invention is to A primary object of the present invention is to provide a method and apparatus for producing polystyrene tubular shrink film via film blow molding, so as to overcome the problems existed in the conventional ways of producing plastic film, such as complicate and big machines, high investment cost, high power consumption, high percentage of scrap, and limited types of usable raw materials.

To achieve the above and other objects, the method for producing polystyrene tubular shrink film via film blow molding according to the present invention includes the steps of using an extruder to extrude a polystyrene plastic material, so as to form a primary blown tubular film; cooling and then uniformly heating the primary blown tubular film with a special hot water tank to soften the primary blown tubular film; blowing hot air into the softened tubular film, and setting two sequentially arranged pressure guide roller sets to two different operating speeds, so that the softened tubular film is transversely and longitudinally stretched and thinned to form a stretched tubular film; guiding the stretched tubular film to pass through a setting treatment system, so that the stretched tubular film is stabilized to form a thermally set tubular film; and winding the thermally set tubular film in a take-up system into a roll for storage. The method and apparatus of the present invention enables continuous processing, and is simple, low cost, and easy to operate. Moreover, the product thereof is environment friendly to help in economic development.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The structure and the technical means adopted by the present invention to achieve the above and other objects can be best understood by referring to the following detailed description of the preferred embodiment and the accompanying drawing, wherein

FIG. 1 is a schematic view of an apparatus for producing polystyrene tubular shrink film via film blow molding according to the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

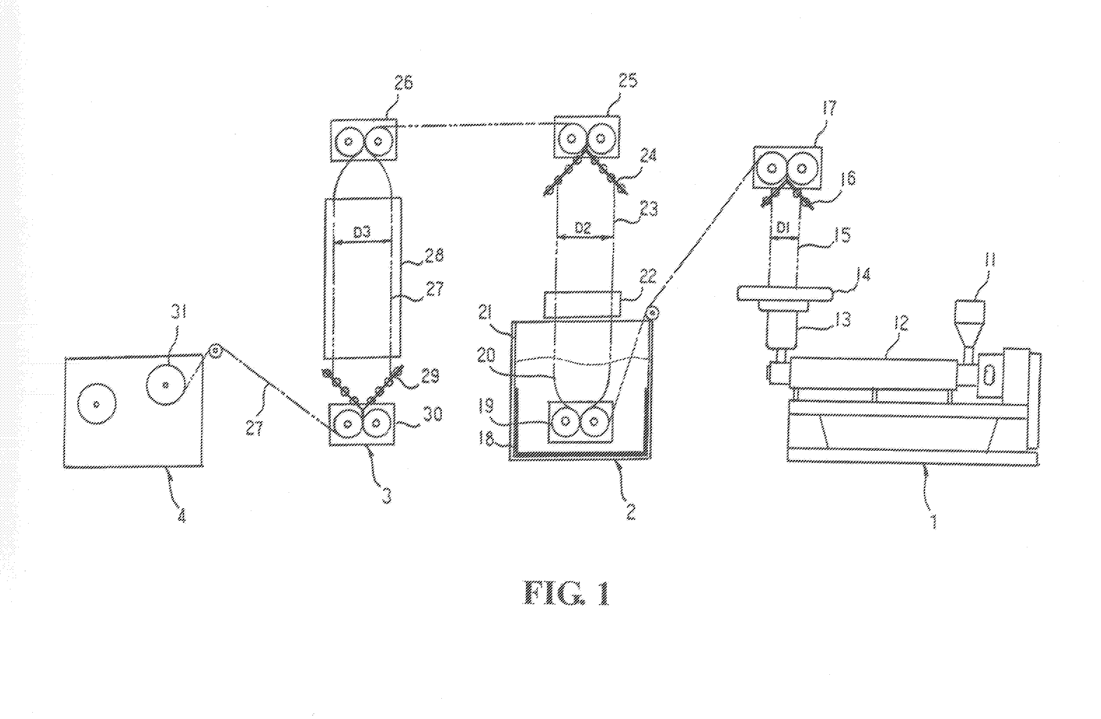

Please refer to FIG. 1 that schematically shows an apparatus for producing polystyrene tubular shrink film via film blow molding according to the present invention. As shown, the apparatus of the present invention includes an extrusion blow molding system 1, a stretch system 2, a setting treatment system 3, and a take-up system 4.

The extrusion blow molding system 1 includes a feed hopper 11, an extruding mechanism 12, a circular extrusion die 13, a circular air-cooler 14, a first pilot plate set 16, and a first speed-controlled pressure guide roller set 17.

The stretch system 2 includes a heater 18, a second speed-controlled pressure guide roller set 19, a hot water tank 21, a circular molding water tank mold 22, a second pilot plate set 24, and a third speed-controlled pressure guide roller set 25.

The setting treatment system 3 includes a fourth speed-controlled pressure guide roller set 26, a hot air circulator 28, a third pilot plate set 29, and a fifth speed-controlled pressure guide roller set 30.

The take-up system 4 includes a plurality of winding rollers 31. A method for producing polystyrene tubular shrink film via film blow molding may be implemented using the above-described apparatus of the present invention via the steps of feeding a polystyrene plastic material to the extruding mechanism 12 via the feed hopper 11 on the extrusion blow molding system 1; using an automatic heating temperature control device in the extruding mechanism 12 to heat the fed polystyrene plastic material to a temperature from about 180° C. to about 230° C., so as to melt the polystyrene plastic material; using an extruder screw to extrude the melted polystyrene plastic material through the circular extrusion die 13, so as to form a cylindrical plastic tube; blowing air into the die-formed plastic tube before the same is passed through and cooled by the circular air cooler 14 to form a primary blown tubular film 15 having a size D1; guiding the primary blown tubular film 15 through the first pilot plate set 16 and the first speed-controlled pressure guide roller set 17, so that the primary blown tubular film 15 is flattened and then led to the hot water tank 21 of the stretch system 2 that is heated by the thermostat-controlled heater 18; continuously heating the primary blown tubular film 15 in the hot water tank 21 at about 80° C. to 100° C. to gradually form a softened tubular film 20; guiding the softened tubular film 20 to pass through the second speed-controlled pressure guide roller set 19 that is operated at a first speed; blowing air into the heated and softened tubular film 20 to expand the same; guiding the expanded tubular film 20 to pass through the circular molding water tank mold 22, so that the expanded tubular film 20 is in contact with the circular molding water tank mold 22 and then cooled by a water-cooling device in the circular molding water tank mold 22 to obtain an increased fixed size D2, that is, the primary blown tubular film 15 having the size D1 has been transversely stretched to form the softened tubular film 20 having the size D2; guiding the transversely stretched tubular film 20 to pass through the second pilot plate set 24 and the third speed-controlled pressure guide roller set 25 that is operated at a second speed higher than the first speed, so that the transversely stretched tubular film 20 is further longitudinally stretched to form a two-directionally stretched tubular film 23 due to a speed difference between the second and the third pressure guide roller set 19, 25, and the two-directionally stretched tubular film 23 is flattened by the second pilot plate set 24 and the third speed-controlled pressure guide roller set 25 and then led to the fourth speed-controlled pressure guide roller set 26 of the setting treatment system 3; guiding the stretched tubular film 23 to pass through the hot air circulator 28, so that the stretched tubular film 23 having the size D2 is in contact with hot air to form a thermally set tubular film 27 having a final size D3; and guiding the thermally set tubular film 27 to pass through the third pilot plate set 29 and the fifth speed-controlled pressure guide roller set 30 before leading the tubular film 27 to the winding rollers 31 of the take-up system 4, so that the thermally set tubular film 27 is finally wound into a roll for storage.

In a preferred embodiment of the present invention, the hot air in the hot air circulator 28 is set to a temperature lower that a plastic softening point and higher than the ambient temperature. That is, the hot air in the hot air circulator 28 has a temperature within the range from about 45° C. to about 65° C. When the cooled two-directionally stretched tubular film 23 is expanded from the flattened state to the circular tubular state by blowing hot air thereinto in the hot air circulator 28, since the temperature of the blown hot air is lower than the plastic softening point, the tubular film 23 is not thermally expanded to stretch. Moreover, in the slow and uniform heating process, the tubular film 20, 23 would be gradually adjusted to reduce an internal stress thereof, so as to maintain its normal stability and form the thermally set tubular film 27, which has good and stable quality, and is not apt to produce uncertain variation due to changes in environment and temperature.

In brief, in the method of the present invention, polystyrene plastic is used as the raw material, which is molded into a primary blown tubular film by an extruding mechanism of the extrusion blow molding system, and the primary blown tubular film is formed into a stretched tubular film by the stretch system. Finally, the stretched tubular film is formed into a thermally set tubular film by the setting treatment system. The apparatus of the present invention for producing polystyrene tubular shrink film via film blow molding is easy to acquire and does not occupy a large space. Therefore, with the apparatus and the method of the present invention, tubular shrink film may be produced using a common thermoplastic and environment friendly plastic material at reduced investment cost to obtain highly economical benefit.

Samples have been made using the method and the apparatus of the present invention, and proven to have good quality in tests. One piece of the samples and a copy of Test Report thereof are submitted along with the application form for the examiner's examination.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An apparatus for producing polystyrene tubular shrink film via film blow molding, comprising:
an extrusion blow molding system including a feed hopper, an extruding mechanism, a circular extrusion die, a circular air-cooler, a first pilot plate set, and a first speed-controlled pressure guide roller set;
a stretch system including a heater, a second speed-controlled pressure guide roller set, a hot water tank, a circular molding water tank mold, a second pilot plate set, and a third speed-controlled pressure guide roller set;
a setting treatment system including a fourth speed-controlled pressure guide roller set, a hot air circulator, a third pilot plate set, and a fifth speed-controlled pressure guide roller set; and
a take-up system including a plurality of winding rollers.

2. A method for producing polystyrene tubular shrink film via film blow molding, being implemented on an extrusion blow molding system, a stretch system, a setting treatment system, and a take-up system; said method comprising the steps of heating a polystyrene plastic material using an automatic heating temperature control device in the extrusion blow molding system, so as to melt the polystyrene plastic material; using an extruder screw to extrude the melted polystyrene plastic material through a circular extrusion die, so as to form a cylindrical plastic tube; blowing air into the die-formed plastic tube before the plastic tube is passed through and cooled by a circular air cooler to form a primary blown tubular film; guiding the primary blown tubular film to pass through a first pilot plate set and a first speed-controlled pressure guide roller set, so that the primary blown tubular film is flattened and then led to a hot water tank of the stretch system to be heated and formed into a softened tubular film; guiding the softened tubular film to sequentially pass through a second speed-controlled pressure guide roller set operating at a first speed, a circular molding water tank mold, a second pilot plate set, and a third speed-controlled pressure guide roller set operating at a second speed higher than the first speed, so that the softened tubular film is longitudinally stretched and thinned due to a speed difference between the third and the second pressure guide roller set to form a stretched tubular film; flattening the stretched tubular film at the second pilot plate set and the third speed-controlled pressure guide roller set before the stretched tubular film is guided to a fourth speed-controlled pressure guide roller set of the setting treatment system; guiding the flattened stretched tubular film through a hot air circulator to contact with hot air and form a thermally set tubular film; and guiding the thermally set tubular film to pass through a third pilot plate set and a fifth speed-controlled pressure guide roller set, so that the thermally set tubular film is led to the take-up system and wound by winding rollers into a roll for storage.

3. The method for producing polystyrene tubular shrink film via film blow molding as claimed in claim 2, wherein the hot air in the hot air circulator of the setting treatment system is set to a temperature between 45° C. and about 65° C., which is lower than a plastic softening point and higher than the ambient temperature; whereby when the stretched tubular film is cooled and then expanded from the flattened state to a circular tubular state by blowing hot air thereinto in the setting treatment system, the stretched tubular film is not thermally expanded to stretch any further, and may have reduced internal stress to maintain a normal stability and form the thermally set tubular film.
